(19) United States
(12) Patent Application Publication
(10) Pub. No.: US 2005/0190145 A1
(43) Pub. Date: Sep. 1, 2005

(54) Method and system for controlling legacy entertainment devices through a data network

(76) Inventors: Daryl Hlasny, Vancouver, WA (US); Garold B. Gaskill, Camas, WA (US)

Correspondence Address: MADSON & METCALF, 15 WEST SOUTH TEMPLE, SUITE 900, SALT LAKE CITY, UT, 84101, US

(21) Appl. No.: 10/786,704

(22) Filed: Feb. 24, 2004

(51) Int. Cl. G09G 5/00

(52) U.S. Cl. 345/156

(57) ABSTRACT

A method and system for controlling legacy entertainment devices through a data network includes a source-side network adaptor for coupling a legacy entertainment source device to a network. The source-side network adaptor is adapted to receive entertainment output of the legacy entertainment source and forward the entertainment output to the network. An output-side network adaptor is also provided for coupling an output device to the network and for receiving selected entertainment output from the network and providing such output to the output device. In addition, the output-side network adaptor is adapted to receive commands from a wireless controller and includes an output selecting module for selecting entertainment output based on one or more commands. Selection of the source-side network adaptor and an associated legacy entertainment source is accomplished automatically. Furthermore, ambiguities that can occur when multiple legacy entertainment sources are responsive to the same wireless controller are managed to allow the user to select the desired legacy source device for display.

### FIELD OF THE INVENTION

The present invention relates to a method and system for logically connecting and controlling legacy entertainment devices, such as televisions, VCR's, and stereo equipment through a data network, such as used in the home.

### BACKGROUND

Audio-visual entertainment devices may be located in different rooms throughout a home, and home data networks are being developed that enable such entertainment devices to be controlled remotely from one location, and which provide the capability to distribute the output of any of the entertainment source devices to any user output device (entertainment destination), regardless of its location in the home. For example, a VCR may be located in a family room and a display device, such as a television or monitor, may be located in another room, such as a bedroom or a kitchen. The home data network permits a user to display the VCR output on the display device. Similarly, the home data network permits a stereo audio source in one room to be played through speakers in another room.

A popular non-proprietary standard for transporting digital data, which is suitable for use as a wired home data network for coupling entertainment devices, is the IEEE 802.3, commonly referred to as Ethernet. Another standard, one that can be used with an Ethernet network, is the “UPnP™” standard. UPnP is intended to allow devices to be easily connected to a network. UPnP supports automatic networking configuration and automatic discovery, whereby a device can dynamically join a network, obtain an Internet Protocol or “IP” address, announce its name, convey its capabilities on request, and learn about the presence and capabilities of other devices on the network.

Generally, home data networks are being developed to provide a number of functions that have not previously been provided in home entertainment systems. For example, the home data network, such as one employing a Ethernet with UPnP™, with new networked home entertainment systems may have the ability to discover entertainment devices on the network, find and select content of interest to the user, select appropriate source devices for rendering the content, select appropriate user output devices (entertainment destinations) for regenerating and outputting the user content, and controlling the devices so that the selected content is provided by the appropriate source device (or devices) and transmitted to the appropriate user output device (or devices).

A limitation of the home data network is that it generally cannot be used with audio-visual entertainment devices that were not specially designed for use with a network. In particular, virtually all existing entertainment devices were not designed for use with a home data network because home data networks are only presently being developed. In addition, future entertainment devices with home data networking capability may be marketed as an extra-cost feature; thus, future low-end entertainment devices may not have networking capabilities. Any such entertainment device without networking capability is referred to herein as a “legacy” entertainment device.

Current legacy entertainment devices typically have an associated remote controller for controlling that device. Typically, the remote controller is wireless and transmits an infrared (“IR”), radio frequency (“RF”), or ultrasonic signal to the legacy entertainment device. Communications between the remote controller and the entertainment device are generally limited to a single room, especially with IR signals as an IR remote control must have a “line of sight” to the entertainment device's IR sensor, although repeaters may be used to overcome this limitation. Generally, a remote controller associated with a particular type of entertainment device or an entertainment device made by a particular manufacturer will not operate entertainment devices of a different type or different manufacturer.

A device known as a remote IR blaster has also been used to control legacy entertainment devices. The IR blaster often connects to a home computer and transfers a received IR signal to another location for retransmission. Transmitting or “blasting” the signals to various rooms essentially provides the function of a repeater for multiple controllers. The IR blaster only has the ability to repeat a signal sent by a transmitter, but has no capability for sending any responsive signal generated by the receiver back to the transmitter. Further, an IR blaster is not a network capable device. While IR blasters can be used to control legacy entertainment devices, they do not connect such devices to a network, and IR blasters do not provide a means for the selectively controlling multiple devices that respond to the same wireless signals.

While remote controllers and IR blasters can control legacy entertainment devices, their capabilities do not provide the connections required in home data networks. These legacy devices do not provide the capability to discover entertainment devices on a network, to find and select content of interest to the user from among multiple entertainment devices, to select appropriate source devices for rendering the content, to select appropriate output devices for outputting the content, or to control the devices so that the selected content is provided by the appropriate source device (or devices) and transmitted to the appropriate output device (or devices). Accordingly, there is a need for a method and system for controlling and connecting legacy entertainment devices through a data network that makes one or more of the features of the home data network described above available for the legacy entertainment devices.

### DESCRIPTION OF THE DRAWINGS

FIG. 1 is a schematic diagram of a prior art home data network.

FIG. 2 is a schematic diagram of a system for controlling legacy entertainment devices through a home data network according to the invention.

FIG. 3 is a flow diagram of a preferred method of the invention.

FIG. 4 is a diagram of an ordered list.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

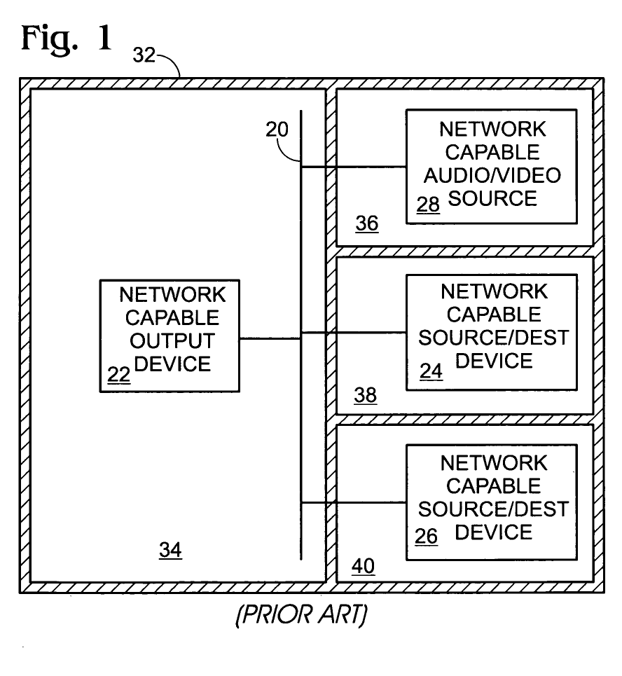

FIG. 1 shows a preferred context for the invention. FIG. 1 is an example of a prior art home data network 20 coupling a network-capable output device 22, two network-capable source/destination devices 24 and 26, and a network-capable audio/video (“AV”) source 28. The output device 22 may be an LCD video display or other similar display device. The network-capable source/destination devices 24, 26 may be video cassette recorders (“VCRs”) capable of playing or recording video, or may be other similar devices. The AV source 28 may be a cable or satellite set-top box, or any other similar AV source, and may include a switch for obtaining input from a plurality of available sources. The term “network-capable” as used herein means that the entertainment devices 22, 24, 26, and 28 include circuitry or a program of instructions for supporting the features of the network 20, and operating according to the protocol thereof.

For purposes of the present application, the home data network 20 can be any type of network, and need not be a network in which all of the interconnected devices and all of the means for connecting such devices are physically disposed within a single building. Preferably, the data network includes UPnP™, which support automatic networking configuration and automatic discovery, whereby a device can dynamically join a network, obtain an IP address, announce its name, convey its capabilities on request, and learn about the presence and capabilities of other devices. The home data network 20 distinguishes between devices by assigning each device a unique network address, for example, an IP address. For this reason, any one device can be specified or selected from among all of the other devices, regardless of its location. Preferably, the home data network 20 is especially adapted for controlling entertainment devices as discussed above, particularly home entertainment devices, and is therefore a home data network provided for use within a home 32; however, the home data network 20 may be used in any other building, such as a hotel, dormitory, hospital, office, or school, and the use of the term “home data network” herein is not intended to be limiting as to the nature or location of use of the network. The home 32 (or other building) typically has two or more rooms 34, 36, 38, and 40.

The devices coupled to the home data network 20 may be disposed in different rooms of the home 32. As shown in FIG. 1, the network-capable output device 22 is located in room 34, the audio/video (“AV”) source 28 is located in room 36, the network-capable source device/destination 24 is located in room 38, and the network-capable source device/destination 26 is located in room 40. Alternatively, two or more of the devices may be disposed in the same room.

The home data network 20 can be used, for example, to permit the network-capable source/destination device 24 (which, it will be recalled, may be a VCR) to record a signal received from AV source device 28. As another example, the home data network 20 can be used to permit a videocassette to be played on network-capable source/destination device 24 with its output being displayed on the network-capable user output device 22.

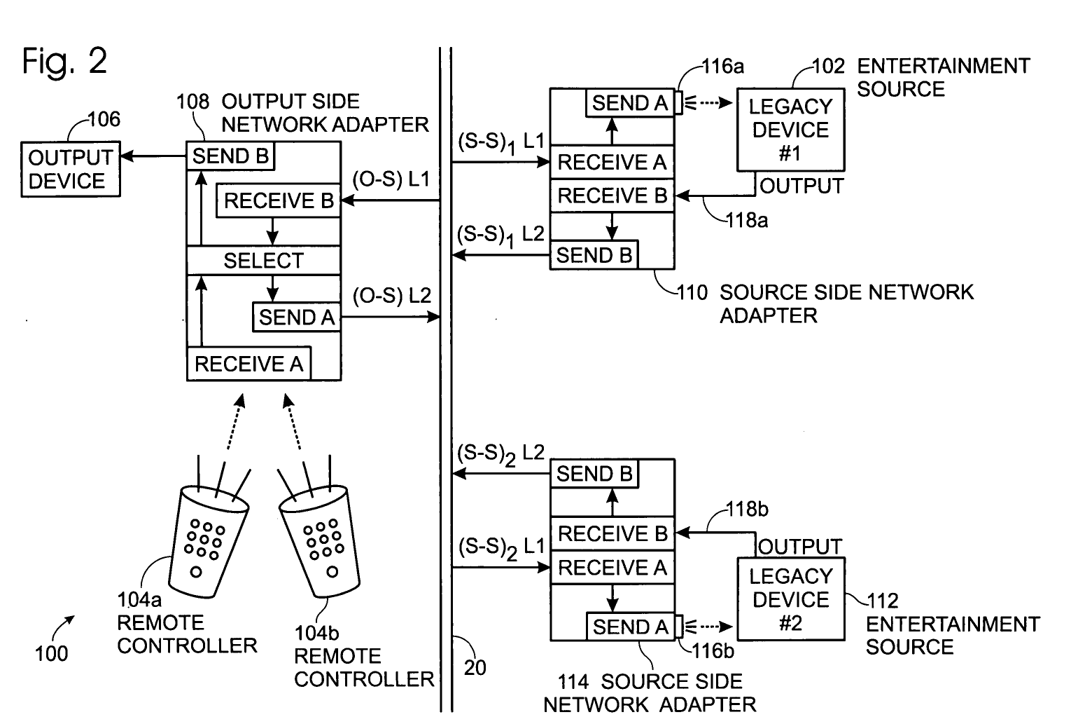

FIG. 2 shows a preferred embodiment of a system 100 for controlling and “connecting” legacy entertainment devices through a home data network 20 according to the present invention. The system 100 is for use with a legacy entertainment source device 102 having an associated remote controller 104a and a user output device 106. The system 100 includes an output-side network adapter 108 and a source-side network adaptor 110. The system 100 may be used with any number of additional legacy entertainment source devices, such as legacy entertainment source device 112, in which case, depending on the number of legacy devices it supports, may require additional source-side network adapters. A second source-side network adapter 114 is provided for source device 112 in the exemplary system shown in FIG. 2. The legacy entertainment source device 112 also has an associated remote controller 104b. The output-side network adapter 108 and all source-side network adapters have a unique network address, which is preferably an IP address.

In a preferred embodiment, as described below, the power button on the remote controller is used to establish a network connection and control the power of the legacy entertainment source. Pushing the power button causes the associated legacy entertainment source to be powered on and its output to be sent to the output-side network adapter 108 sending the control data to be displayed, preferably on user output device 106.

The remote controllers 104a and 104b are typical of those used with consumer-grade home entertainment devices and therefore have a low data rate and are wireless. The remote controllers 104a, 104b transmit coded instructions (“commands”) to their respective legacy entertainment source devices for controlling their operation. Legacy entertainment source devices may be of different manufacture, or different models, and the codes used for operating different devices will generally, though not necessarily, be different. Generally, to operate a legacy entertainment source device 102, 112 with its associated remote controller 104a, 104b, the remote controller (and its operator) must be in the same room as the legacy entertainment source device. The reason for this requirement is that the signal produced by the remote controller is generally a short-range signal. For example, the maximum operating distance for the remote controller may be about 7 meters. Another reason is that the remote controller, in order for its signal to be received, must generally be positioned so that the signal it transmits is within a prescribed angle, typically 30°, of a center line perpendicular to a signal sensor on the legacy entertainment source device.

The devices coupled to the home data network 20 may be disposed in different rooms of a home. For purposes of illustrating a first aspect of the invention, at least one of the legacy entertainment source devices 102, 112 is in a different room than the output-side network adaptor 108. It will be appreciated, however, that the legacy entertainment source devices may be in the same room, though it is preferable that the various devices be positioned so that any legacy source device does not receive signals from more than one of the blasters of the source-side network adaptors, which are described below.

The output-side network adapter 108 includes a “receive A” module for receiving commands transmitted by the remote controllers 104, an output selecting module (“select”), a “send A” module for sending commands to the network 20 on output-side line(s) 2 (“(O-S) L2”), a “receive B” module for receiving entertainment output and other signals from the network 20 on output-side line(s) 1 (“(O-S) L1”), and a “send B” module for sending entertainment output to the user output device 106.

The output-side network adapter 108 is adapted for receiving transmissions from remote controllers 104. In particular, the output-side network adapter 108 is adapted for receiving transmissions from remote controllers 104a and 104b. The output-side network adapter 108 may be provided as an integral part of the user output device 106. Alternatively, the output-side network adapter 108 may be provided as a stand-alone unit as shown. The output-side network adapter 108 need not be able to distinguish between codes that are intended for local control of the output device 106 and control of legacy entertainment source devices 102, 112.

When the output-side network adapter 108 receives a first command from a remote controller 104, it digitizes the code received (preferably by employing an analog-to-digital converter, that is not shown), and provides the digitized command to the network 20 along with an address or addresses provided by the output selecting module. The output selecting module is adapted to select one or more source-side network adaptors for receipt of the digitized command. Preferably, the output selecting module selects all of source-side network adaptors coupled to the network 20 for receipt of the digitized command. Thus, the digitized command is placed on the network along with one or more network addresses defining recipients of the command.

The source-side network adaptors 110, 114 include a “receive A” module for receiving digitized commands described above from the network 20 over respective source-side line(s) (S-S)₁ L1 and (S-S)₂ L1, a “send A” module for transmitting commands for receipt by a legacy entertainment source device, a “receive B” module for receiving entertainment output from a legacy entertainment source device, and a “send B” module for sending entertainment output and other signals to the network 20 over respective source-side line(s) (S-S)₁ L2 and (S-S)₂ L2. The source-side network adaptors 110, 114 are coupled to legacy entertainment source devices 102, 112, respectively, by output lines 118a, 118b. In addition, each of the source-side network adaptors 110, 114 includes at least one blaster 116 for “blasting” an analog signal to an associated legacy entertainment source device.

When the source-side network adaptors 110, 114 receive from the network 20 a digital command transmitted by the output-side network adapter 108, they convert the digitized command signal back into an analog command signal (preferably by employing a digital-to-analog converter, that is not shown), and blast the analog signal to an associated legacy entertainment source device. After a digitized command has been received, converted to an analog command, and blasted to a legacy entertainment source device, the legacy entertainment source device is monitored to determine if the command activated (or de-activated) the source device.

The blasters 116a, 116b are adapted to reproduce the digitized command as a signal in the manner and mode of transmission required for the particular legacy entertainment source device 102, 112 associated with a remote controller 104a, 104b. For example, if the originating remote controller 104a employs coded IR transmissions for a legacy device 102, the blaster 116a associated with the legacy device 102 must be able to blast the IR transmissions to the device 102 using the same codes and the same manner (e.g., frequency) and mode (e.g., IR or sonic) of transmission. To provide effective blasting, at least the blasters 116 of the source-side network adaptors 110, 114 are typically disposed in the same room as their associated legacy entertainment source device

Monitoring of the legacy entertainment source device to determine if the command activated the source device may be accomplished in a variety of ways. Preferably, the source-side network adaptors are designed to detect changes in the output of legacy entertainment source devices. This detection capability includes the ability to detect presence or absence of entertainment output signals on output lines 118. This detection of a response can be simple as monitoring the input voltage of the legacy source devices for changes from no voltage to a non-zero voltage or for particular patterns in frequency or time. This may also include digital methods which include detecting a change in source streams on the network via source addresses being present or not present in the streams.

Several examples are presented below which illustrate how a network constructed in accordance with the principles of the invention operates. In a first example, a user presses the “power” key on the remote controller 104a to create a command. In this example, the user presses the power key for a normal length of time, which is referred to herein as a “short-pulse.” The output-side network adaptor 108 receives this command, digitizes it, and transmits it over the network 20. The source-side network adaptors 110, 114 receive the command and blast the command code to all of the legacy entertainment source devices. Typically, some of the legacy entertainment source devices 102, 112 will respond (i.e., become activated or de-activated) to the command code and some will not. The legacy source devices that are responsive will either turn ON, if they were previously OFF, or turn OFF, if they were previously ON. The source-side network adaptor 108 is adapted to monitor and flag the power-on status, i.e., whether the devices are ON or OFF and the output status of the legacy source devices.

As a second example, a user creates another command by pressing the power key on the other remote controller 104b. The user again presses the power key for the short-pulse time period. As was the case in the first example, the output-side network adaptor 108 receives the command, digitizes it, and transmits it over the network 20. As before, the source-side network adaptors 110, 114 receive the command and blast the command code to all of the legacy entertainment source devices. Again, some of the legacy entertainment source devices 102, 112 will generally respond to the command code by becoming activated and some will not. In this example, those legacy sources which are responsive to remote controller 104b will be identified.

Consider an example where only legacy entertainment source device 102 is responsive to remote controller 104a. This example refers generally to the situation where not more than one legacy entertainment source device on the network is responsive to the same set of commands. In this situation, the source-side network adaptors 110, 114 blast remote controller 104a's commands to all of the legacy entertainment source devices on the network 20, but only the legacy entertainment source device that is responsive to the particular set of commands (i.e., source device 102) will respond and have its entertainment output placed on the network. In this situation, the particular legacy entertainment source device may be instructed to provide entertainment output to the user output device 106 merely by the fact that it is the only legacy entertainment source device responsive to the commands necessary to operate that device.

Next consider the situation where more than one legacy entertainment source device is responsive to the same set of commands. This situation typically arises when there are two or more identical legacy entertainment source devices, for example, the legacy source 102 is the same make and model as legacy source 112; hence, the remote controller 104a is the same as the remote controller 104b and transmits the same set of commands. According to another aspect of the invention, the system 100 is preferably adapted, as explained below, to resolve any ambiguities in the responses received by the output-side network adaptor 108.

The output-side network adaptor 108 is adapted to resolve these ambiguities by making an ordered list of all the legacy entertainment source devices responsive to a particular command, and by selecting one of the listed legacy source devices for connection to the network 20. The output-side network adaptor 108 identifies the source-side network adaptor associated with the selected legacy source device, and causes the entertainment output of the selected legacy device to be displayed on the user output device 106. In addition, the output-side network adaptor 108 keeps track of the fact that the selected legacy entertainment source has been selected by “flagging” the legacy entertainment source on the ordered list.

The selected entertainment output is displayed on user output device 106 where it is viewed by the user. If the user wishes to view the selected output, no further action is required. However, the user may not wish to view it. Preferably, the user may signal a desire to have the command applied to another legacy entertainment source device by transmitting another short-pulse power command from the remote controller 104a. When the output-side network adaptor 108 receives this short-pulse power command, it is adapted to select the next legacy entertainment source device on the ordered list for that power command. By selecting the next legacy entertainment source device on the ordered list, the output-side network adaptor 108 causes its entertainment output to be displayed on the user output device 106.

Preferably, the output-side network adaptor 108 determines the next legacy entertainment device on the list by simply repeating the process described above. The output-side network adaptor 108 selects a second legacy entertainment source device from the list that was not flagged initially. Similarly, if the user declines connection to the second legacy entertainment source device, a third short-pulse power command instructs the source-side network adaptor 108 to select a third legacy entertainment source device by choosing a legacy entertainment source device from the list that was not flagged on either the first or second power command, and so on. Thus, in a preferred embodiment, a user can repeat the procedure of pressing the power button for a short-pulse indefinitely. Each time the power button is pressed the entertainment output of the next legacy entertainment source device on the ordered list is displayed. When the end of the list is reached, the first source device on the list is selected. The phrase “recursive trial and error method” is used herein to refer to this and similar techniques for selecting between the entertainment outputs provided by the various legacy entertainment source devices on the network.

Other methods, as well as variations on the above described method, may be employed to signal that the next device on the list be selected. For example, a predetermined key, such as the “power” key, on the remote controller may be pressed quickly in succession to signal that another legacy source device should be selected. If the user wants to power down all of the legacy source devices, the output-side network adaptor 108 may be adapted to recognize this as a result of the user pressing the “power” key for a time that is longer than the normal time, i.e., a “long-pulse” as opposed to the aforementioned short-pulse. Many other means of signaling the same intention may be used as will be readily appreciated.

If a legacy entertainment source device is in a separate room apart from the other entertainment source devices on the list, it may be desired to transmit the short-pulse power command only in the room where the legacy source device is located (if it is OFF), and blasting a short-pulse power command to any remaining legacy entertainment devices located in other rooms (if they are ON) so as to turn them OFF.

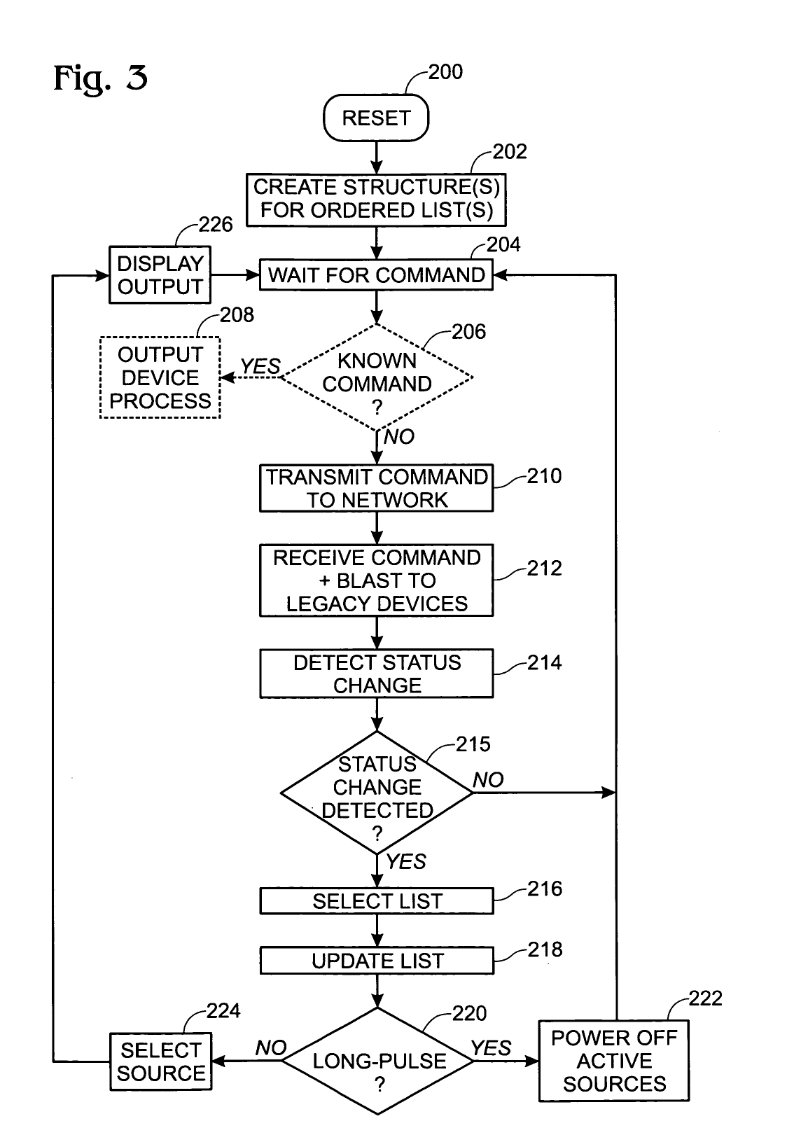

A flow diagram illustrating a preferred method according to the invention is shown in FIG. 3. After a reset in a first step 200, the structure(s) for one or more ordered list(s) is created in step 202, and the method proceeds to step 204 of waiting for a command from a remote controller.

A determination is made in the optional step 206 as to whether a received command is a known command, such as a command for control of the user output device 106, or not. If the code is known, an optional output device process is performed in step 208

In step 210 the code is transformed into a digital command, addresses of source-side network adaptors are selected, and the digital command is sent over the network to the selected addresses. In a step 212, the source-side network adaptors receive the digital command, convert it to an analog command, and blast the command to their associated legacy entertainment source.

In step 214, the selected source-side network adaptors detect whether their associated legacy entertainment source devices experienced a status change as a result of the command blasted in step 212.

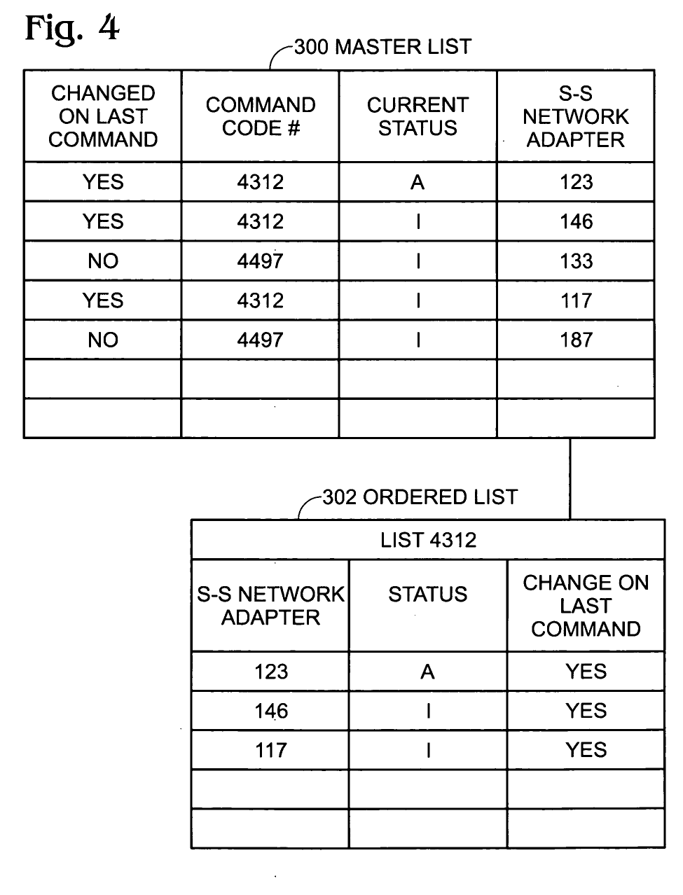

The selected source-side network adaptors notify the output-side network adaptor over the network as to whether their associated legacy entertainment source experienced a status change as a result of the command blasted in step 212. A determination is made in step 215 as to whether any devices experienced a status change, and if no devices had a status change, the system returns to the “wait for command” step 204. On the other hand, if at least one device experienced a status change, then the appropriate ordered list will be selected in a step 216 if there is more than one ordered list. In a step 218, the selected ordered list is updated. FIG. 4 shows one preferred embodiment of an ordered list 302 derived from a master list 300.

A determination is made in step 220 as to whether the command is of long or short duration. If the command is of long duration, active legacy entertainment source devices are powered off in step 222, and the method returns to the wait for command step 204. If the command is of short duration, the output-side network adaptor selects a network address in step 224.

The address selected in step 224 is the address of the source-side network adaptor associated with one of the legacy entertainment source devices for which a status change was detected in step 214. If only one legacy entertainment source responded to the short-pulse command, the address of the network adaptor for that source is selected. If more than one legacy entertainment source responded, one of the legacy entertainment sources is arbitrarily selected. In a preferred embodiment, the next legacy entertainment source on the list is selected. If no legacy entertainment sources have been previously selected from the list or if all of the sources on the list have been previously selected, the first legacy entertainment source on the list is considered the “next” device and is selected.

In a step 226, the entertainment output of the legacy entertainment source selected in step 224 is displayed on the user output device 106. The method then proceeds to step 204 of waiting for another command.

If the user wishes to view the entertainment output for the source selected in step 224, no further steps occur.

If the user wishes to view entertainment output from a source other than the source selected in step 224, and does not wish to view any other legacy source, the user uses the remote controller to generate another short-pulse command. The steps of the method are performed as described above, except that in step 224, the “next” legacy entertainment source on the list is selected. The selected legacy entertainment source is different from the legacy entertainment source previously selected. The user may repeat this “recursive trial and error method” any number of times until the legacy entertainment source he wishes to view is selected.

If the user wishes to stop viewing the entertainment output for the source selected in step 224, he uses the remote controller to generate a long-pulse command. The long-pulse command is detected in step 220 and all active legacy entertainment sources are turned off in step 222.

The terms “short-pulse” and “long-pulse” have been used herein with reference to command signals from a remote controller 104. The duration of a short-pulse is a “short time,” such as for example 0.1 to 0.5 seconds, and the duration of a long-pulse is a “long time,” such as for example, 2 seconds or more. These durations are exemplary and may be adjusted as desired.

It is to be recognized that, while preferred methods and system according to the present invention have been shown and described, other methods and system incorporating one or more of the features described herein may be employed without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A system for adapting one or more legacy entertainment sources for coupling to and remote operation over a network, to provide selected entertainment output of the sources to an output device, the system comprising:
a first source-side network adaptor for coupling a first one of the one or more legacy entertainment sources to the network, said first source-side network adaptor being adapted for receiving first entertainment output of said first legacy entertainment source and forwarding said first entertainment output to the network; and
an output-side network adaptor for coupling the output device to the network and receiving one or more first commands from a first wireless controller capable of operating said first legacy entertainment source, said output-side network adaptor including an output selecting module for selecting said first entertainment output based on said one or more first commands.

2. The system of claim 1, wherein said output-side network adaptor is further adapted for receiving the selected said first entertainment output from the network and providing the selected said first entertainment output to the output device.

3. The system of claim 2, wherein said first source-side network adaptor is adapted for indicating to said output selecting module whether a first condition that said first legacy entertainment source is activated by said one or more first commands is true, and wherein said output selecting module is adapted for selecting said first entertainment output only if said first condition is true.

4. The system of claim 3, wherein said output-side network adaptor is further adapted for receiving one or more other commands from a second wireless controller capable of operating a second one of the legacy entertainment sources, wherein the system further comprises a second source-side network adaptor for coupling said second legacy entertainment source to the network, for receiving second entertainment output of said second legacy entertainment source, for forwarding said second entertainment output to the network, and for indicating to said output selecting module whether an other condition that said second legacy entertainment source is activated by said one or more other commands is true, and wherein said output selecting module is further adapted for selecting said second entertainment output only if said other condition is true.

5. The system of claim 1, wherein said first source-side network adaptor is adapted for indicating to said output selecting module whether a first condition that said first legacy entertainment source is activated by said one or more first commands is true and said output selecting module is adapted for selecting said first entertainment output only if said first condition is true, the system further comprising a second source-side network adaptor for coupling a second one of the legacy entertainment sources to the network, said second source-side network adaptor being adapted for receiving second entertainment output of said second legacy entertainment source and indicating to said output selecting module whether a second condition that said second legacy entertainment source is activated by said one or more first commands is true, wherein said output selecting module is adapted for selecting said second entertainment output based on one or more second commands from said wireless controller.

6. The system of claim 5, wherein said output-side network adaptor is further adapted for receiving the selected said second entertainment output from the network and providing the selected said second entertainment output to the output device.

7. The system of claim 5, wherein said output selecting module is adapted for selecting said first entertainment output based on one or more third commands from said first wireless controller.

8. The system of claim 5, wherein said first wireless controller includes an input switch adapted, upon activation by a user thereof, to transmit a power command capable of powering said first and said second legacy entertainment devices on or off, wherein said one or more second commands includes said power command, and wherein said output-side network adaptor is adapted to recognize a duration of said activation and, if said duration is within a first predetermined range, select said second entertainment output and send said power command to said first source-side network adaptor for blasting to said first legacy entertainment device, for turning off said first legacy entertainment device.

9. The system of claim 8, wherein, if said duration is within a second predetermined range distinct from said first range, said output-side network adaptor is adapted to send said power command to said first and second source-side network adaptors for blasting to both of said first and second legacy entertainment devices, for turning off both said first and second legacy entertainment devices.

10. The system of claim 9, wherein said switch is adapted for activation by pressing said switch, and wherein said first predetermined range corresponds to pressing said switch a short time and wherein said second predetermined range corresponds to pressing said switch a long time.

11. A method for adapting one or more legacy entertainment sources for coupling to and remote operation over a network, to provide selected entertainment output of the sources to an output device, the method comprising:
receiving first entertainment output of said first legacy entertainment source and forwarding said first entertainment output to the network;
receiving one or more first commands from a first wireless controller capable of operating said first legacy entertainment source; and
selecting said first entertainment output based on said one or more first commands.

12. The method of claim 11, further comprising receiving the selected said first entertainment output from the network and providing the selected said first entertainment output to the output device.

13. The method of claim 12, further comprising determining whether a first condition that said first legacy entertainment source is activated by said one or more first commands is true and selecting said first entertainment output only if said first condition is true.

14. The method of claim 13, further comprising:
receiving one or more other commands from a second wireless controller capable of operating a second one of the legacy entertainment sources;
receiving second entertainment output of said second legacy entertainment source and forwarding said second entertainment output to the network;
determining whether an other condition that said second legacy entertainment source is activated by said one or more other commands is true; and
selecting said second entertainment output only if said other condition is true.

15. The method of claim 11, further comprising determining whether a first condition that said first legacy entertainment source is activated by said one or more first commands is true, selecting said first entertainment output only if said first condition is true, receiving second entertainment output of said second legacy entertainment source, determining whether a second condition that said second legacy entertainment source is activated by said one or more first commands is true, and selecting said second entertainment output based on one or more second commands from said first wireless controller.

16. The method of claim 15, further comprising receiving the selected said second entertainment output from the network and providing the selected said second entertainment output to the output device.

17. The method of claim 15, further comprising selecting said first entertainment output based on one or more third commands from said first wireless controller.

18. The method of claim 15, wherein said first wireless controller includes an input switch adapted, upon activation by a user thereof, to transmit a power command capable of powering said first and said second legacy entertainment devices on or off, and wherein said one or more second commands includes said power command, the method further comprising recognizing a duration of said activation and, if said duration is within a first predetermined range, selecting said second entertainment output and sending said power command to said first source-side network adaptor for blasting to said first legacy entertainment device, for turning off said first legacy entertainment device.

19. The method of claim 18, wherein, if said duration is within a second predetermined range distinct from said first range, the method further comprises sending said power command to said first and second source-side network adaptors for blasting to both of said first and second legacy entertainment devices, for turning off both said first and second legacy entertainment devices.

20. The method of claim 19, wherein said switch is adapted for activation by pressing said switch, and wherein said first predetermined range corresponds to pressing said switch a short time and wherein said second predetermined range corresponds to pressing said switch a longer time.
